(19) United States
(12) Patent Application Publication
(10) Pub. No.: US 2014/0097717 A1
(43) Pub. Date: Apr. 10, 2014

(54) FLUID DYNAMIC PRESSURE BEARING APPARATUS AND SPINDLE MOTOR

(71) Applicant: MINEBEA CO., LTD., Kitasaku-gun (JP)

(72) Inventors: Jun HATCHO, Kitasaku-gun (JP); Hideo FUJIURA, Saku-shi (JP)

(73) Assignee: MINEBEA CO., LTD., Kitasaku-gun (JP)

(21) Appl. No.: 14/029,072

(22) Filed: Sep. 17, 2013

(30) Foreign Application Priority Data
Oct. 4, 2012 (JP) 2012-222416

(51) Int. Cl. F16C 32/06; H02K 7/08

(52) U.S. Cl. CPC F16C 32/0629; H02K 7/08
USPC 310/90; 384/100

(57) ABSTRACT

There is provided a fluid dynamic pressure bearing apparatus including a shaft, a bearing sleeve rotatably supporting the shaft, and a lubricating oil filled between the shaft and the bearing sleeve, wherein at least one of the shaft and the bearing sleeve is formed of a copper alloy containing 0.8 wt % to 5 wt % of lead, and a base oil of the lubricating is a member selected from the group consisting of monoester, dibasic acid diester, diol ester and mixtures thereof, and the lubricating oil contains 0.1 wt % to 1 wt % of condensed phosphate ester. The fluid dynamic pressure bearing apparatus is capable of suppressing the hydrolysis of the lubricating oil, and the wear of the shaft and the bearing sleeve.

### CROSS REFERENCE TO RELATED APPLICATION

The present application claims priority from Japanese Patent Application No. 2012-222416 filed on Oct. 4, 2012 the disclosure of which is incorporated herein by reference in its entirety.

### BACKGROUND OF THE INVENTION

1. Field of the Invention

The present invention relates to a fluid dynamic pressure bearing apparatus and a spindle motor provided with the same.

2. Description of the Related Art

Spindle motors used in information devices have been miniaturized and made thinner in the recent years. In association with this trend, there are growing demands for spindle motors that have superior rotational precision with reduced run-out and that generate lower noise. In order to satisfy these demands, a slide bearing apparatus such as a fluid dynamic pressure bearing apparatus or an oil-impregnated sintered bearing apparatus is appropriately adopted for the bearing of a spindle motor. For example, the fluid dynamic pressure bearing apparatus is used in a polygon mirror scanner motor which rotates at a high speed exceeding 40,000 rpm.

Japanese Patent Application Laid-open No. 2004-51719 discloses an oil-impregnated bearing apparatus using an oil for oil-impregnated bearing in which tricresyl phosphate as a friction modifier is added to an ester oil.

The ester oil has low viscosity and thus is suitable as the bearing oil for the high rotational speed application, and the friction modifier suppresses the wear in a shaft and/or a bearing sleeve contacting the bearing oil.

However, the fluid dynamic pressure bearing apparatus used in a motor such as the polygon mirror scanner motor which rotates at high speed is easily heated, and a lubricating oil used in the fluid dynamic pressure bearing apparatus is required to have further lowered viscosity and enhanced thermal resistance more than ever. Although the ester oil has low viscosity, the ester oil is easily hydrolyzed by heat and moisture, which in turn shorten the service life of the oil under a severe operational condition with high temperature and high humidity. Further, a fluid bearing apparatus rotating at high speed requires an enhanced resistance against the wear in the shaft and the bearing sleeve contacting the lubricating oil. Accordingly, there is a demand for a lubricating oil which is capable of suppressing the wear in the shaft and bearing sleeve and which is hardly hydrolyzed, and for a fluid dynamic pressure bearing using such lubricating oil.

### SUMMARY OF THE INVENTION

An object of the present invention is to provide a fluid dynamic pressure bearing apparatus capable of suppressing both of the hydrolysis of the lubricating oil and the wear in the shaft and the bearing sleeve. Another object of the present invention is to provide a spindle motor using such fluid dynamic pressure bearing apparatus.

According to the first aspect of the present invention, there is provided a fluid dynamic pressure bearing apparatus including: a shaft; a bearing sleeve rotatably supporting the shaft; and a lubricating oil filled between the shaft and the bearing sleeve; wherein at least one of the shaft and the bearing sleeve is formed of a copper alloy containing 0.8 wt % to 5 wt % of lead; and a base oil of the lubricating oil is a member selected from the group consisting of monoester, dibasic acid diester, diol ester and mixtures thereof, and the lubricating oil contains 0.1 wt % to 1 wt % of condensed phosphate ester.

According to the second aspect of the present invention, there is provided a spindle motor including: a fluid dynamic pressure bearing apparatus having a shaft, a bearing sleeve rotatably supporting the shaft, and a lubricating oil filled between the shaft and the bearing sleeve; a rotor configured to rotate about the shaft; and a stator configured to cooperate with the rotor to generate a rotation moment; wherein at least one of the shaft and the bearing sleeve is formed of a copper alloy containing 0.8 wt % to 5 wt % of lead; and a base oil of the lubricating oil is a member selected from the group consisting of monoester, dibasic acid diester, diol ester and mixtures thereof, and the lubricating oil contains 0.1 wt % to 1 wt % of condensed phosphate ester.

In the fluid dynamic pressure bearing apparatus or the spindle motor, a dynamic pressure generating groove may be formed on at least one of an outer circumferential surface of the shaft and an inner circumferential surface of the bearing sleeve.

The monoester used as base oil of the lubricating oil may be a monoester obtained from esterification of straight-chain or branched-chain aliphatic monocarboxylic acid having 10 to 18 carbons with saturated straight-chain aliphatic monohydric alcohol having 8 to 10 carbons or saturated branched-chain aliphatic monohydric alcohol having 8 to 16 carbons. Further, the diester used as base oil may be a diester obtained from esterification of aliphatic dibasic acid having 2 to 12 carbons with saturated straight-chain or branched-chain aliphatic alcohol having 3 to 22 carbons. Further, the diol ester used as base oil may be a diol ester obtained from esterification of saturated straight-chain or branched-chain aliphatic monocarboxylic acid having 4 to 18 carbons with saturated straight-chain aliphatic dihydric alcohol having 2 to 10 carbons or saturated branched-chain aliphatic dihydric alcohol having one branch or two or more branches and having 2 to 10 carbons.

The condensed phosphate ester contained in lubricating oil may be a member selected from the group consisting of resorcinol bis(diphenylphosphate), resorcinol bis(dixylenyl phosphate), bisphenol-A bis(diphenylphosphate) and mixtures thereof. In particular, the lubricating oil may contain dioctyl sebacate as the base oil and resorcinol bis(diphenylphosphate) as the condensed phosphate ester.

The lubricating oil may contain 0.1 wt % to 0.5 wt % of the condensed phosphate ester. Further, the lubricating oil may contain 0.25 wt % to 1.0 wt % of the condensed phosphate ester. Furthermore, the lubricating oil may contain 0.25 wt % to 0.5 wt % of the condensed phosphate ester.

The copper alloy may be brass containing copper and zinc. Further, the shaft may be formed of stainless steel, and the bearing sleeve may be formed of the copper alloy containing 0.8 wt % to 5 wt % of lead.

### BRIEF DESCRIPTION OF THE DRAWINGS

FIG. 1 is a cross-sectional view of a fluid dynamic pressure bearing apparatus according to the first embodiment, and of a spindle motor according to the second embodiment provided with the fluid dynamic pressure bearing apparatus.

FIG. 2A is a side view of the shaft shown in FIG. 1, and FIG. 2B is a cross-sectional view of the bearing sleeve shown in FIG. 1.

FIG. 3 shows a relationship between the test duration time (testing time) and the mass reduction rate of the lubricating oil in Test 1 for evaluating hydrolysis in lubricating oil.

FIG. 4 shows a relationship between the lead content rate in an alloy and the mass reduction rate of the lubricating oil in Test 2 for evaluating hydrolysis in lubricating oil.

FIG. 5 shows a relationship between the content rate of condensed phosphate ester in the lubricating oil and the mass reduction rate of the lubricating oil in Test 3 for evaluating hydrolysis in lubricating oil.

FIG. 6 shows a relationship between the content rate of phosphate ester and the diameter of wear mark (wear scar) in Frictional Wear Test.

### DESCRIPTION OF THE PREFERRED EMBODIMENTS

### First Embodiment

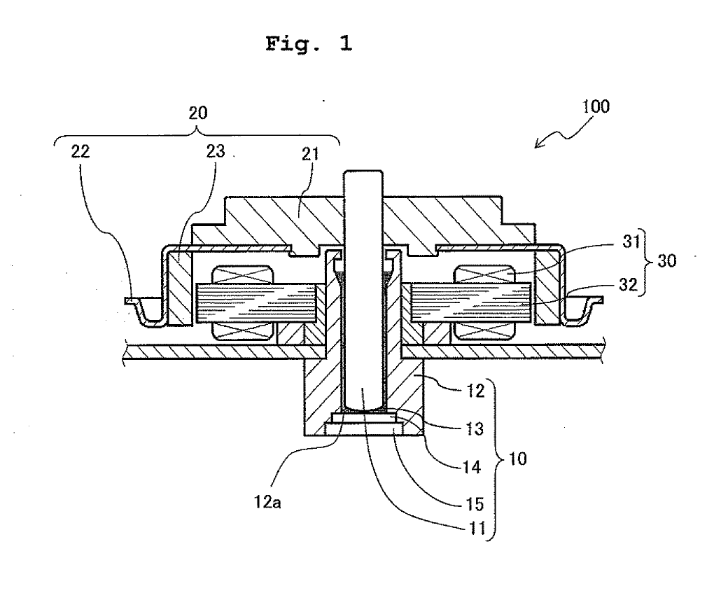

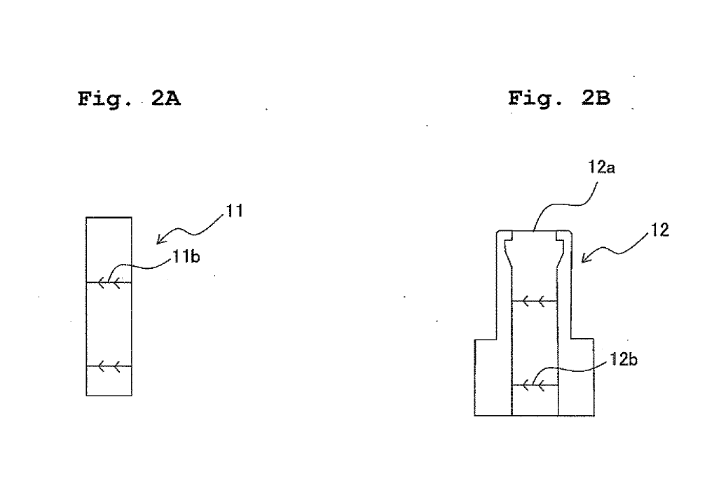

As a first embodiment, a fluid dynamic pressure bearing apparatus used in a spindle motor will be explained. As shown in FIG. 1, a fluid dynamic pressure bearing apparatus 10 used in a spindle motor 100 is mainly composed of a shaft 11, a cylindrical-shaped bearing sleeve 12 configured to accommodate the shaft 11, and a lubricating oil 13 filled in a minute gap between the shaft 11 and the bearing sleeve 12. A disc-shaped sliding plate 14 configured to receive the shaft 11 and a blocking plate 15 configured to cover a lower end portion of the bearing sleeve 12 and to be fixed to the bearing sleeve 12 are attached to the lower end portion of the bearing sleeve 12. The shaft 11 is supported to be rotatable (rotatable on its axis) in a through hole 12a of the bearing sleeve 12. As shown in FIGS. 2A and 2B, herringbone-shaped or spiral-shaped dynamic pressure generating grooves 11b, 12b are formed on the outer circumferential surface of the shaft 11 and/or the inner circumferential surface of the bearing sleeve 12, i.e. the surface defining the through hole 12a. In the present embodiment, the dynamic pressure generating groove is formed on the inner circumferential surface of the bearing sleeve 12. However, the dynamic pressure generating groove may be formed on the outer circumferential surface of the shaft 11, instead of the inner circumferential surface of the bearing sleeve 12.

In the fluid dynamic pressure bearing apparatus 10 related to the present embodiment, at least one of the shaft 11 and the bearing sleeve 12 is composed of a copper alloy containing 0.8 wt % to 5 wt % of lead. The inventors of the present application found out that by composing the base oil of the lubricating oil 13, used together with such a copper alloy, of a member selected from the group consisting of monoester, dibasic acid diester, diol ester and mixtures thereof, and by allowing the lubricating oil to contain 0.1 wt % to 1 wt % of condensed phosphate ester, it is possible to provide a fluid dynamic pressure bearing apparatus capable of suppressing the hydrolysis of the lubricating oil and having the durability sufficient for long service life under high rotational speed.

The copper alloy composing at least one of the shaft 11 and the bearing sleeve 12 contains 0.8 wt % to 5 wt % of lead, and the preferred content rate of lead in the copper alloy is 2 wt % to 5 wt %. The copper alloy related to the present embodiment may include metals such as zinc, iron, nickel, manganese, silver and tin. In particular, brass which is mainly composed of copper and zinc is preferred. The brass includes, for example, brasses with alloy numbers of C3531, C3601, C3602, C3603, C3604 and C3605 as defined by Japanese Industrial Standards (JIS H3250: 2012). These brasses contain 1.0 wt % to 4.0 wt % of lead, 56.0 wt % to 64.0 wt % of copper, 27 wt % to 41.2 wt % of zinc, and not more than 0.8 wt % of iron. Both of the shaft 11 and the bearing sleeve 12 may be formed of the copper alloy containing lead, or only one of the shaft 11 and the bearing sleeve 12 may be formed of the copper alloy containing lead. In a case that only one of the shaft 11 and the bearing sleeve 12 is formed of the lead-containing copper alloy, it is preferred that the bearing sleeve 12 is formed of one of the lead-containing copper alloys described above, in view of securing sufficient rigidity for the shaft. On the other hand, in a case that one of the shaft 11 and the bearing sleeve 12 is formed of the lead-containing copper alloy, it is preferred that the other of the shaft 11 and the bearing sleeve 12 is formed of stainless steel which can be processed with high precision.

The base oil of the lubricating oil 13 used in the fluid dynamic pressure bearing apparatus 10 related to the embodiment is an ester oil which is monoester, dibasic acid diester, diol ester or mixtures thereof. It is preferred that these esters are carboxylate ester. Examples of the monoester include monoester of straight-chain or branched-chain aliphatic monocarboxylic acid having 10 to 18 carbons represented by the following general formula (1) and saturated straight-chain aliphatic monohydric alcohol having 8 to 10 carbons or saturated branched-chain aliphatic monohydric alcohol having 8 to 16 carbons.

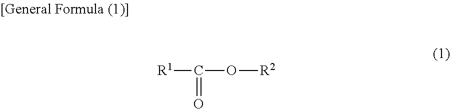

(In the general formula (1), represents straight-chain or branched-chain alkyl group having 9 to 17 carbons, and R² represents straight-chain alkyl group having 8 to 10 carbons or branched-chain alkyl group having 8 to 16 carbons.)

Examples of the dibasic acid diester include diester of aliphatic dibasic acid having 2 to 12 carbons represented by the following general formula (2), and saturated straight-chain or branched-chain aliphatic alcohol having 3 to 22 carbons. The examples of the aliphatic dibasic acid having 2 to 12 carbons include oxalic acid, malonic acid, succinic acid, glutaric acid, adipic acid, pimelic acid, suberic acid, azelaic acid, sebacic acid, 1,9-nonamethylene dicarboxylic acid and 1,10-decamethylene dicarboxylic acid. In particular, dioctyl sebacate (DOS) obtained from esterification of dibasic acid having 10 carbons with monohydric alcohol having 8 carbons is preferred.

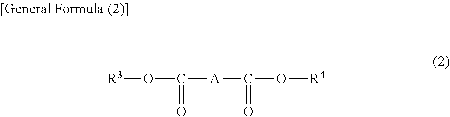

(In the general formula (2), R³ and R⁴ each represent straight-chain or branched-chain alkyl group having 3 to 22 carbons, R³ and R⁴ may be the same or different from each other, and A represents direct bond or straight-chain alkylene group having 1 to 10 carbon(s)).

Examples of the diol ester include diester of saturated straight-chain aliphatic dihydric alcohol having 2 to 10 carbons, preferably 3 to 10 carbons, or saturated branched-chain aliphatic dihydric alcohol having one branch or two or more branches and having 2 to 10 carbons, preferably 3 to 10 carbons, as represented by the following general formula (3), and saturated straight-chain or branched-chain aliphatic monocarboxylic acid having 4 to 18 carbons.

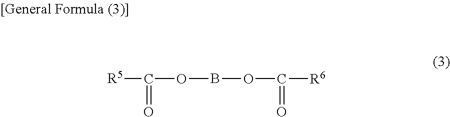

(In the general formula (3), R⁵ and R⁶ each represent straight-chain or branched-chain alkyl group having 3 to 17 carbons, R⁵ and R⁶ may be the same or different from each other, and B represents straight-chain alkylene group having 2 to 10 carbons or branched-chain alkylene group having 2 to 10 carbons and having 1 or 2 or more branches).

As the base oil of the lubricating oil, any one of the above-described ester compounds may be used individually, or any two or more kinds of the above-described ester compounds may be used in combination. In particular, dioctyl sebacate (DOS) represented by the general formula (2) has low viscosity and superior thermal stability, and thus is preferred as the base oil. Since the ester oil explained above has low viscosity, it is preferred as the lubricating oil for the fluid dynamic pressure bearing apparatus. Further, by using the lubricating oil in combination with the shaft or the bearing sleeve which is formed of a copper alloy containing 0.8 wt % to 5 wt % of lead, it is possible to suppress the hydrolysis of the ester oil, and to prolong the service life of the fluid dynamic pressure bearing apparatus even when used under severe operational condition of high temperature and high humidity.

The base oil is preferably contained in an amount of 96 wt % to 99 wt % in the lubricating oil, and is further preferably contained in an amount of 98 wt % to 99 wt % in the lubricating oil. Further, the content of the base oil in the lubricating oil may be, for example, balance of the other components of the lubricating oil.

The lubricating oil 13 contains 0.1 wt % to 1 wt % of condensed phosphate ester. Examples of the condensed phosphate ester include aromatic condensed phosphate esters such as resorcinol bis(diphenylphosphate) (RDP) represented by the following formula (4), resorcinol bis(dixylenyl phosphate) (RDX) represented by the following formula (5), bisphenol-A bis(diphenylphosphate) (BDP) represented by the following formula (6), etc.

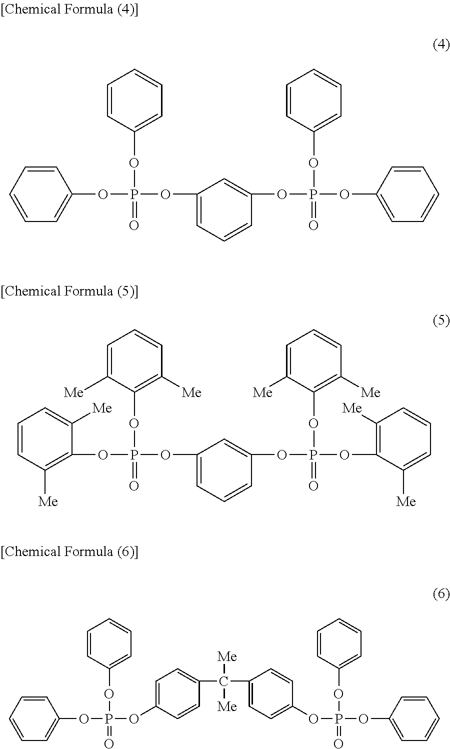 [SMILES: O=P(Oc1ccccc1)(Oc1ccccc1)Oc1cccc(OP(=O)(Oc2ccccc2)Oc2ccccc2)c1 ; Cc1cccc(C)c1OP(=O)(Oc1cccc(OP(=O)(Oc2c(C)cccc2C)Oc2c(C)cccc2C)c1)Oc1c(C)cccc1C ; CC(C)(c1ccc(OP(=O)(Oc2ccccc2)Oc2ccccc2)cc1)c1ccc(OP(=O)(Oc2ccccc2)Oc2ccccc2)cc1]

The condensed phosphate ester may be used individually, or any two or more kinds of the condensed phosphate ester may be used in combination. Further, resorcinol bis(diphenylphosphate) (RDP) represented by the chemical formula (4) and having a superior effect of suppressing the friction and the wear of the shaft and the bearing sleeve which contact the lubricating oil is a preferred example of the condensed phosphate ester.

The above-described condensed phosphate ester contained in the lubricating oil 13 related to the embodiments is an extreme pressure additive reducing the friction and the wear of the shaft 11 and the bearing sleeve 12 in the fluid dynamic pressure bearing apparatus 10. The extreme pressure additive reduces the friction and the wear of the shaft and the bearing sleeve. On the other hand, an excessive amount of extreme pressure additive may accelerate the hydrolysis of the lubricating oil in some cases. In the present embodiment, however, the lubricating oil containing 0.1 wt % to 1 wt % of the condensed phosphate ester is used in the fluid dynamic pressure bearing apparatus in combination with the shaft or the bearing sleeve formed by the copper alloy containing 0.8 wt % to 5 wt % of lead, to thereby suppress the hydrolysis of the lubricating oil. With this combination, the lubricating oil of the embodiment is capable of suppressing the hydrolysis of the ester oil (lubricating oil) as well as of containing sufficient amount of the extreme pressure additive for realizing the friction resistance property and wear resistance property (frictional wear resistance property), thereby making it possible to improve the durability of the fluid dynamic pressure bearing apparatus and to increase the service life of the fluid dynamic pressure bearing apparatus. Further, the condensed phosphate ester of the embodiment can develop superior friction resistance and wear resistance properties even when the condensed phosphate ester is contained at a small content rate like 0.1 wt % to 1 wt %.

As described above, since the lubricating oil contains 0.1 wt % to 1 wt % of the condensed phosphate ester, the fluid dynamic pressure bearing apparatus related to the embodiment can satisfy both of the properties for suppressing the hydrolysis of the lubricating oil and for suppressing the friction and wear of the shaft and the bearing sleeve. However, in order to suppress the hydrolysis of the lubricating oil, it is preferred that 0.1 wt % to 0.5 wt % of the condensed phosphate ester is contained in the lubricating oil. On the other hand, from the point of view of suppressing the friction and/or wear of the shaft and the bearing sleeve, it is preferred that 0.25 wt % to 1.0 wt % of the condensed phosphate ester is contained in the lubricating oil. Accordingly, for suppressing both the hydrolysis of the lubricating oil and the friction and/or wear of the shaft and the bearing sleeve, it is particularly preferred that 0.25 wt % to 0.5 wt % of the condensed phosphate ester is contained in the lubricating oil.

In the lubricating oil of the embodiment, it is preferred that the base oil is dioctyl sebacate (DOS) and that the condensed phosphate ester is resorcinol bis(diphenylphosphate) (RDP). The lubricating oil having such a composition has low viscosity, can sufficiently suppress the wear of the shaft and the bearing sleeve, and is further highly effective in suppressing the hydrolysis when combined with the shaft or the bearing sleeve formed of the lead-containing copper alloy as described above. Further, it is preferred that the lubricating oil containing dioctyl sebacate (DOS) and resorcinol bis(diphenylphosphate) (RDP) is used in combination with at least one of a shaft and a bearing sleeve formed of free-cutting brass (JIS C3604). The free-cutting brass (JIS C3604) is particularly effective in suppressing the hydrolysis of the lubricating oil having the above-described composition.

The lubricating oil of the embodiment may further contain an antioxidant, a corrosion inhibitor, a metal deactivator and the like, and other components which are conventionally used in lubricating oils.

The lubricating oil of the embodiment can be prepared by uniformly mixing the following: a base oil that is any one of monoester, dibasic acid diester and dial ester; the condensed phosphate ester; and other additive(s) as necessary, according to any known method.

Although the fluid dynamic pressure bearing apparatus 10 related to the embodiment can be used in the spindle motor as shown in FIG. 1, the invention is not limited to this example. The fluid dynamic pressure bearing apparatus according to the invention may be used in a variety of purposes. For example, the fluid dynamic pressure bearing apparatus 10 may be used in a fan motor and the like.

### Second Embodiment

A spindle motor provided with the fluid dynamic pressure bearing apparatus related to the first embodiment will be explained. A spindle motor 100 shown in FIG. 1 is mainly provided with the fluid dynamic pressure bearing apparatus 10, a rotor 20 rotating about the shaft 11 as the axis of rotation thereof, and a stator 30 configured to interact (cooperate) with the rotor 20 so as to generate rotation moment (torque). The stator 30 is provided with a stator core 32 having a coil 31 wound therearound, and is arranged to be rotationally symmetric with respect to and around the fluid dynamic pressure bearing apparatus 10. The rotor 20 is provided with a hub 21 fixed to the shaft 11, a cylindrical-shaped rotor yoke 22 arranged to cover the outer portion of the stator 30, and a magnet 23. The rotor yoke 22 is connected to the shaft 11 via the hub 21, and the magnet 23 is arranged on the inner circumferential surface of the rotor yoke 22 at a position which faces the stator core 32.

In the spindle motor 100, when the rotor 20 rotates about the shaft 11 as the axis of rotation, the shaft 11 itself fixed to the hub 21 also rotates about its axis due to the rotation of the rotor 20. At this time, the lubricating oil 13 between the shaft 11 and the bearing sleeve 12 is made to flow along the groove patterns of the dynamic pressure generating grooves 11b, 12b shown in FIG. 2, and is pumped so as to locally generate a high-pressure zone in the lubricating oil 13, thereby causing the lateral surface (outer circumferential surface) of the rotating shaft 11 to be supported by the bearing sleeve 12 and causing the bottom surface of the rotating shaft 11 to be supported by the sliding plate 14.

The spindle motor 100 can be used, for example, as a polygon mirror scanner motor usable in a laser writing system of a digital copying machine and the like. The polygon mirror scanner motor rotates at a high speed exceeding 40,000 rpm and reflects laser light beam from a semiconductor laser to direct the reflected laser light beam to a photoconductive drum. The bearing apparatus is easily heated at the high rotational speed exceeding 40,000 rpm. Therefore, the lubricating oil is required to suppress the hydrolysis even under a high temperature and further the shaft and bearing sleeve are required to have sufficient wear resistance. The spindle motor 100 related to the second embodiment uses the fluid dynamic pressure bearing apparatus 10 related to the first embodiment. In the fluid dynamic pressure bearing apparatus 10, at least one of the shaft 11 and the bearing sleeve 12 is formed of the copper alloy containing 0.8 wt % to 5 wt % of lead, and by using the shaft 11 and/or the bearing sleeve 12 formed of the copper alloy containing 0.8 wt % to 5 wt % of lead in combination with the lubricating oil 13 containing the specific ester as the base oil and 0.1 wt % to 1 wt % of the condensed phosphate ester, it is capable of suppressing both of the hydrolysis of the lubricating oil 13 and the wear of the shaft 11 and the wear of the bearing sleeve 12. Accordingly, the fluid dynamic pressure bearing apparatus 10 and the spindle motor 100 can have the durability under a service condition requiring high-speed rotation and can have prolonged service life.

Although the spindle motor 100 related to the embodiment can be used as the polygon mirror scanner motor rotating at a high speed, the invention is not limited to this example. The spindle motor according to the present invention can be used also as a spindle motor of a hard disk drive (HDD) and the like.

### EXAMPLES

The present invention will be explained with the following examples. However, the present invention is not limited to the following examples.

### (1) Test 1 for Evaluating Hydrolysis in Lubricating Oil

Samples of lubricating oil with immersed metal were prepared by immersing different kinds of metals in the lubricating oil, and the effect of the respective metals on the hydrolysis of the lubricating oil was evaluated.

### [Preparation of Samples 1 to 5]

At first, dioctyl sebacate (DOS), resorcinol bis(diphenylphosphate) (RDP), an antioxidant, a corrosion inhibitor and a metal deactivator were mixed uniformly to prepare a lubricating oil “a1”. Here, dioctyl sebacate (DOS) is an ester oil used as the base oil, resorcinol bis(diphenylphosphate) (RDP) is a condensed ester functioning as the extreme pressure additive, and the antioxidant, the corrosion inhibitor and the metal deactivator are the group of the other additives. The lubricating oil a1 was prepared to have a composition containing 0.5 wt % of resorcinol bis(diphenylphosphate) (RDP), and total amount of 1 wt % of the other additives, i.e. the antioxidant, the corrosion inhibitor and the metal deactivator.

Samples 1 to 4 were prepared by immersing four kinds of metals, namely brass 1 (JIS C3604), brass 2 (JIS C6804), stainless steel (DHS1 (trade name), manufactured by Daido Steel Co, Ltd.) and lead respectively, in the previously prepared lubricating oil a1. Further, Sample 5 consisting only of the lubricating oil a1 was prepared. In Samples 1 to 4, the mass ratio of the lubricating oil a1 in relation to the metal was made to be 10:2. Note that the brass 1 contains lead, whereas the brass 2 does not contain lead. The lead content rate of the brass 1 was measured by the X-ray Fluorescence Analysis (XRF); the lead content rate of the brass 1 was 3.07 wt %.

### [Method for Performing Test 1 for Evaluating Hydrolysis in Lubricating Oil]

Since the amount of hydrolysis in the ester oil is minute under the room temperature and normal humidity environment, acceleration test was performed according to the following method. An unsaturated-type highly accelerated life testing machine (PC-304R8 (trade name) manufactured by Hirayama Manufacturing Corporation) was used to perform HAST test (Highly Accelerated Stress Test) in accordance with Japanese Industrial Standards (JIS) C60068-2-66, entitled “Environmental testing—Part 2: Test methods—Test Cx: Damp heat, steady state (unsaturated pressurized vapour)”. In this test, Samples 1 to 5 were kept for 100 hours in the following humidity unsaturated environment: a temperature of 120 degrees Celsius and a relative humidity of 95%. The mass of each of Samples 1 to 5 was measured before starting the test and every 25 hours after starting the test; and the mass reduction rate of the lubricating oil for each of Samples 1 to 5 was obtained based on the mass change of the lubricating oil. The ester is hydrolyzed into acid and alcohol by heat and moisture. The acid and alcohol produced by the hydrolysis are easily evaporated as compared with the ester, and thus any one of or both of the acid and alcohol is/are preferentially evaporated than the ester. Therefore, the mass reduction is more prominent in a lubricating oil in which hydrolysis has occurred than in a lubricating oil in which hydrolysis has not occurred. This means, consequently, that the hydrolysis is more progressed in the lubricating oil exhibiting higher mass reduction rate. Note that the accelerated test was performed on the premise that most of the mass reduction in the lubricating oil is caused by the hydrolysis.

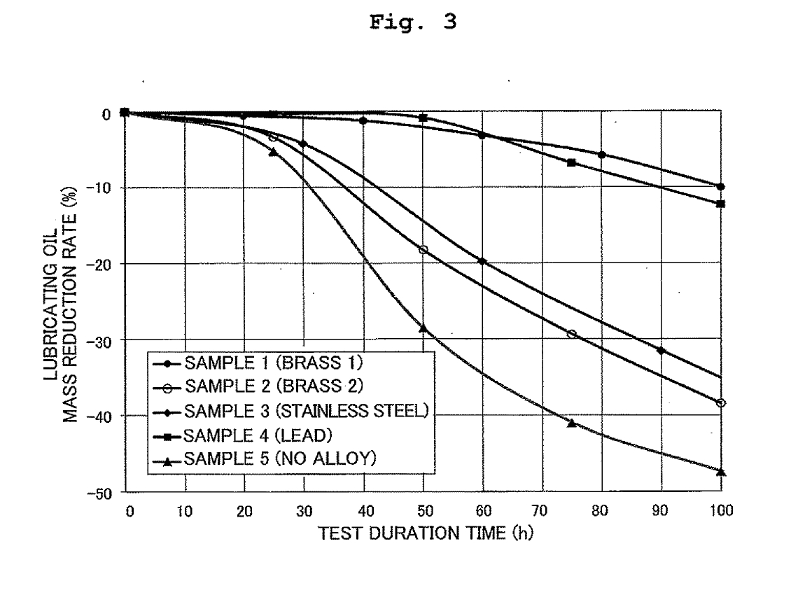

As shown in FIG. 3, the mass reduction rate of the lubricating oil after elapse of 100 hours since the start of the test was small in order of Sample 1 (brass 1), Sample (lead), Sample 3 (stainless steel), Sample 2 (brass 2) and Sample 5 (consisting only of lubricating oil). In particular, Sample 1 (brass 1) containing the lead and Sample 4 (lead) each had a very low mass reduction rate of the lubricating oil after elapse of 100 hours since the start of the test, that was not more than 15%.

### (2) Test 2 for Evaluating Hydrolysis in Lubricating Oil

Samples were prepared by immersing alloys with different lead content rates in the lubricating oil, and the effect of the lead content rate to the hydrolysis of the lubricating oil was evaluated.

### [Preparation of Samples 6 to 14]

Nine kinds of alloys were prepared in which the content rate of lead was respectively 0.1, 0.5, 1.0, 1.5, 2.0, 3.0, 5.0, 7.5 and 10.0 wt %, and the balance was copper. Samples 6 to 14 were prepared respectively by immersing each of these alloys in the lubricating oil a1. The mass ratio of the lubricating oil a1 in relation to the alloy was made to be 10:2 in each of Samples 6 to 14.

### [Method for Performing Test 2 for Evaluating Hydrolysis in Lubricating Oil]

HAST test was performed for Samples 6 to 14 in a similar manner as that in the above-described method for performing Test 1 for evaluating the hydrolysis in lubricating oil, except that the test duration time was 50 hours during which Samples 6 to 14 were kept in the high humidity and high temperature environment. The mass of each of Samples 6 to 14 after finishing the HAST test was measured, and the mass reduction rate of the lubricating oil was obtained for each of Samples 6 to 14 based on the mass change in the lubricating oil.

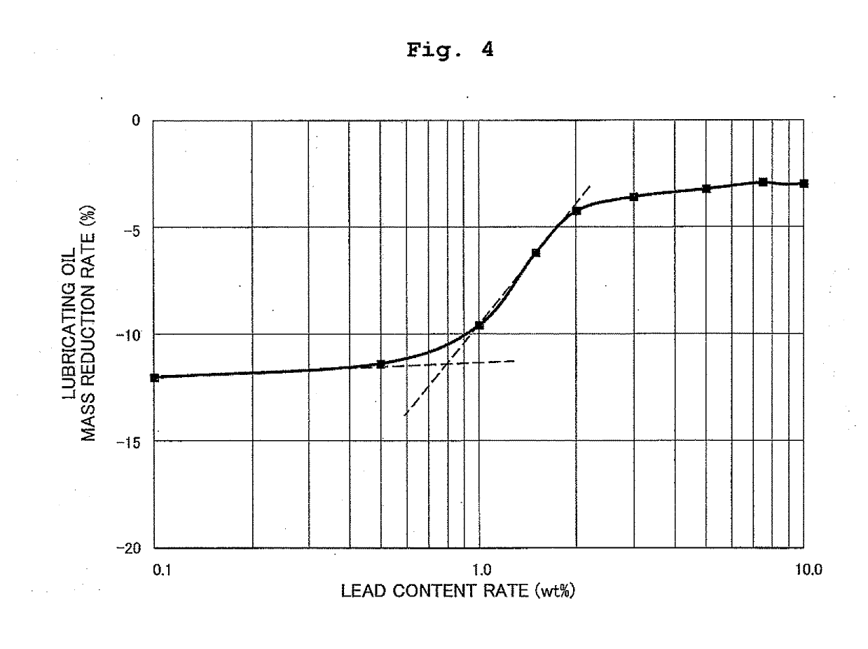

As shown in FIG. 4, the mass reduction rate of the lubricating oil starts to decrease when the alloy immersed in the lubricating oil a1 contains the lead at the content rate of about 0.8 wt %. This shows that when the copper alloy containing 0.8 wt % or more of lead is brought into contact with the lubricating oil, the hydrolysis of the lubricating oil is suppressed. When the lead content rate in the copper alloy exceeds 0.8 wt %, the mass reduction rate of the lubricating oil further decreases as the lead content rate in the alloy increases; however, the effect of decreasing the mass reduction rate becomes moderate when the lead is contained in the alloy at the content rate of 2 wt % or more, and is substantially saturated at the lead content rate of more than 5 wt %. Since the lead content rate is preferred to be low in view of the impact on the environment, the lead content rate in the alloy is preferably not more than 5 wt %.

From the results of Tests 1 and 2 for evaluating hydrolysis in lubricating oil, it was found out that when a copper alloy containing 0.8 wt % to 5 wt % of lead, preferably containing 2 wt % to 5 wt % of lead, is immersed in the lubricating oil containing condensed phosphate ester, the hydrolysis of the lubricating oil can be suppressed. Accordingly, in the case that the copper alloy containing 0.8 wt % to 5 wt % of lead is used for at least one of the shaft and the bearing sleeve of the fluid dynamic pressure bearing apparatus, it is possible to suppress the hydrolysis of the lubricating oil containing the condensed phosphate ester. The reason for this is presumed as follows. Generally, phosphate ester decomposes into phosphate by heat generated during the rotation of the bearing apparatus and moisture, and is considered to function as the extreme pressure additive by forming a film of phosphate with superior frictional wear resistance on surface of the shaft and/or the bearing sleeve. On the other hand, however, phosphate existing in an excess amount functions as a catalyst for the hydrolysis of the ester oil. In the embodiment, it is presumed that the phosphate or the condensed phosphate ester preferentially adsorbs to the lead surface in the copper alloy, thereby reducing the amount of the condensed phosphate ester or the phosphate released in the lubricating oil which functions as the catalyst of the hydrolysis of the ester oil, and successfully suppressing the hydrolysis. Accordingly, it is presumed that a similar test result to that described above would be obtained with a lubricating oil containing the specific ester as the base oil thereof and containing 0.1 wt % to 1 wt % of the condensed phosphate ester. Although the lubricating oil a1 is evaluated in the embodiment, the lubrication oil of the present invention is not limited to the lubricating oil a1.

### (3) Test 3 for Evaluating Hydrolysis in Lubricating Oil

Samples were prepared by immersing alloys in a lubricating oil with different content rates of the condensed phosphate ester, and the effect of the content rate of the condensed phosphate ester on the hydrolysis of the lubricating oil was evaluated. Further, two kinds of alloys, one containing lead and the other not containing lead, were used and the effect on the hydrolysis of the lubricating oil due to this difference was also evaluated.

### [Preparation of Samples 15 to 36]

As the lubricating oils, the above-described lubricating oil a1 containing 0.5 wt % of the condensed phosphate ester was prepared. In addition, ten kinds of lubricating oils containing the condensed phosphate ester in amounts of 0.005, 0.01, 0.05, 0.1, 0.3, 1.0, 3.0, 5.0, 8.0 and 10.0 wt % respectively, and each having a composition similar to that of the lubricating oil a1 except for the content rate of the condensed phosphate ester, were prepared. Next, as the alloy, brass 1 (JIS 03604) containing 3.07 wt % of lead was prepared and immersed in each of the above-described eleven kinds of lubricating oils. Accordingly, eleven kinds of samples of oil with immersed metal were obtained. The obtained samples were designated as Samples 15 to 25 in ascending order of the content rate of the condensed phosphate ester in the lubricating oil. Further, brass 2 (JIS C6804) not containing lead was prepared and immersed in each of the eleven kinds of lubricating oils. Accordingly, eleven kinds of samples were obtained. The obtained samples were designated as Samples 26 to 36 in ascending order of the content rate of the condensed phosphate ester in the lubricating oil. Note that the mass ratio of the lubricating oil in relation to the alloy was made to be 10:2 in each of Samples 15 to 36.

### [Method for Performing Test 3 for Evaluating Hydrolysis in Lubricating Oil]

HAST test was performed for Samples 15 to 36 in a similar manner as that in the above-described method for performing Test 1 for evaluating the hydrolysis in lubricating oil, except that the test duration time was 50 hours during which Samples 15 to 36 were kept in the high temperature and high humidity environment. The mass of each of Samples 15 to 36 after finishing the HAST test was measured, and the mass reduction rate of the lubricating oil was obtained for each of Samples 15 to 36 based on the mass change in the lubricating oil.

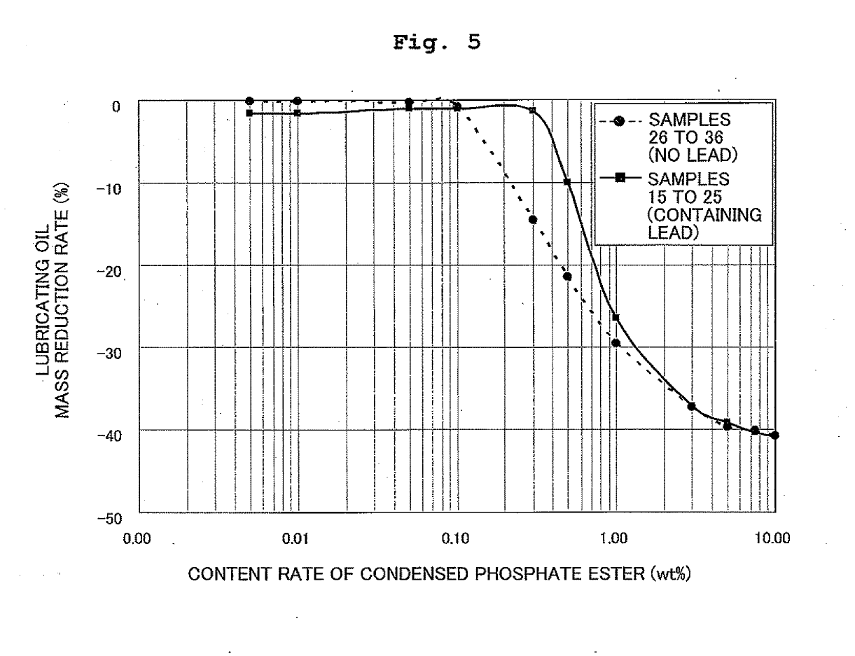

As shown in FIG. 5, the mass reduction rate of the lubricating oil was slight when the content rate of the condensed phosphate ester in the lubricating oil was in a range of 0.005 wt % to 0.1 wt % in both of Samples 15 to 25 in each of which brass 1 containing lead was immersed and Samples 26 to 36 in each of which brass 2 not containing lead was immersed. This shows that the hydrolysis of the lubricating oil was slight. Further, regarding Samples 15 to 25 in each of which brass 1 containing lead was immersed, the mass reduction rate of the lubricating oil increased when the content rate of the condensed phosphate ester in the lubricating oil was not less than 0.30 wt %; and regarding Samples 26 to 36 in each of which brass 2 not containing lead was immersed, the mass reduction rate of the lubricating oil increased when the content rate of the condensed phosphate ester in the lubricating oil was not less than 0.10 wt %. The cause for these phenomena was presumed that the amount of the phosphate released in the lubricating oil or the amount of the phosphate ester increased, and the phosphate or the phosphate ester started to function as the catalyst for hydrolyzing the ester oil.

Furthermore, with respect to the lubricating oil with the content rate of the condensed phosphate ester in the range of 0.10 wt % to 1.0 wt %, the samples with brass 1 containing lead immersed in the lubricating oil (Samples 15 to 25) showed a lower mass reduction rate of the lubricating oil than the samples with brass 2 not containing lead immersed in the lubricating oil (Samples 26 to 36). This indicates that the hydrolysis of the lubricating oil containing 0.10 wt % to 1.0 wt % of the condensed phosphate ester was suppressed due to the immersion of brass 1 containing lead. In particular, the mass reduction rate of the lubricating oil was slight in the lubricating oils with the content rate of the condensed phosphate ester in a range of 0.10 wt % to 0.3 wt %, wherein the hydrolysis of the lubricating oil was strongly suppressed. In FIG. 5, it is considered that the mass reduction rate of the lubricating oil of up to about 10% is satisfactory. Therefore, from the viewpoint of suppressing the hydrolysis of the lubricating oil, the condensed phosphate ester is preferably contained in the lubricating oil in an amount of 0.1 wt % to 0.5 wt %. Note that when the content rate of the condensed phosphate ester in the lubricating oil exceeded 1 wt %, there was little difference in the mass reduction rate of the lubricating oil between Samples 15 to 25 in each of which brass 1 containing lead was immersed and Samples 26 to 36 in each of which brass 2 not containing lead was immersed in the lubricating oil.

### (4) Frictional Wear Test

Lubricating oils with different content rates of the condensed phosphate ester were prepared to perform the frictional wear test, and the property of the condensed phosphate ester as the extreme pressure additive was evaluated. Further, a lubricating oil containing non-condensed phosphate ester, instead of the condensed phosphate ester, was also prepared for comparison, and the frictional wear test was similarly performed as well.

[Preparation of Samples (Lubricating Oils “a1” to “a6”, “b1” to “b3”, “c3” and “e”]

As samples, a lubricating oil “a1” containing the condensed phosphate ester in an amount of 0.5 wt % was prepared. In addition, five kinds of lubricating oils “a2” to “a6” containing the condensed phosphate ester in amounts of 0.01, 0.05, 0.10, 0.25 and 1.00 wt % respectively, and each having a composition similar to that of the lubricating oil a1, except for the content rate of the condensed phosphate, were prepared. Further, three kinds of lubricating oils “b1” to “b3” were prepared each with a composition similar to that of the lubricating oil a1, except that the tricresyl phosphate (TCP), which is a non-condensed phosphate ester, replaced the condensed phosphate ester. The tricresyl phosphate (TCP) was added in the lubricating oils “b1” to “b3” as the extreme pressure additive in amounts of 0.5, 1.0 and 2.0 wt % respectively. Furthermore, a lubricating oil “c1” was prepared with a composition similar to that of the lubricating oil a1, except that the trixylenyl phosphate (TXP), which is a non-condensed phosphate ester, replaced the condensed phosphate ester. The trixylenyl phosphate (TXP) was added in the lubricating oil “c” as the extreme pressure additive in an amount of 0.5 wt %. Moreover, a lubricating oil “e” having a composition similar to that of the lubricating oil a1, except for not containing any extreme pressure additive, was prepared.

### [Method for Performing Frictional Wear Test]

Four-ball wear test was performed for the prepared lubricating oils a1 to a6, b1 to b3, c1 and e. The four-ball wear test was run for 60 minutes under the following conditions: a temperature of 75 degrees Celsius, rotational speed of 1,200 rpm, and load of 392N, in accordance with the standard ASTM D2266-01, and the diameter of wear mark after the test was measured for each of the samples.

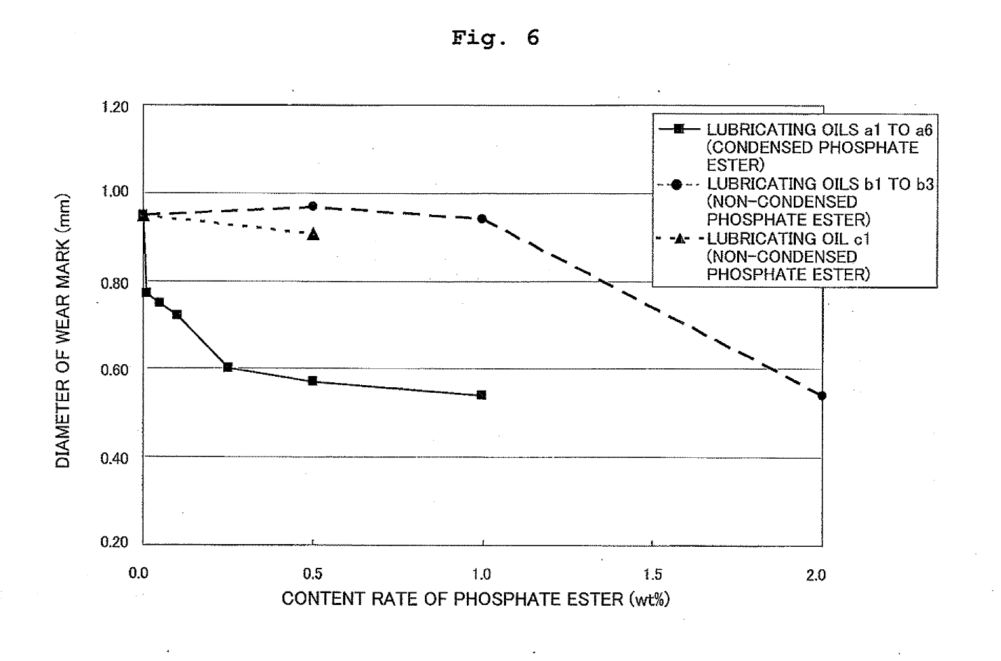

As shown in FIG. 6, with respect to the lubricating oils a1 to a6 containing the condensed phosphate ester in the amount of not less than 0.01 wt %, the diameter of the wear mark decreased. This shows that the condensed phosphate ester becomes effective as the extreme pressure additive when the lubricating oil contains not less than 0.01 wt % of the condensed phosphate ester, and that the wear of the shaft and the bearing sleeve can be suppressed if the lubricating oil containing not less than 0.01 wt % of the condensed phosphate ester is used in the fluid dynamic pressure bearing apparatus. As the content rate of the condensed phosphate ester was increased, the diameter of wear mark decreased. In the cases that the content rate of the condensed phosphate ester were not less than 0.25 wt % (lubricating oils a1, a5 and a6), the diameter of wear mark did not exceed 0.6 mm, achieving particularly remarkable wear suppressing effect. In the cases that the content rate of the condensed phosphate ester were not less than 0.25 wt % (lubricating oils a1, a5 and a6), the decrease of the diameter of wear mark became moderate, and with the content rate of the condensed phosphate ester of 1.0 wt % (lubricating oil a6), the decrease of the diameter of wear mark was substantially saturated.

With respect to the lubricating oils b1 to b3, each containing the tricresyl phosphate (TCP) that is a non-condensed phosphate ester, the effect of decreasing the diameter of wear mark was not observed until the content rate of the TCP exceeding 1 wt % (lubricating oils b2 and b3). This shows that with the TCP that is a non-condensed phosphate ester, the effect as the extreme pressure additive is obtained when the TCP is contained in an amount of 1 wt % or more. Further, with respect to the lubricating oil c1 containing the trixylenyl phosphate (TXP) that is also a non-condensed phosphate ester, satisfactory decrease of the diameter of wear mark was not observed, and the effect of TXP as the extreme pressure additive was modest.

As described above, it was found out that the condensed phosphate ester develops superior frictional resistance and superior wear resistance compared to the non-condensed phosphate ester, even when the condensed phosphate ester is contained in the lubricating oil in a small content rate. The reason therefor is not clear but it is presumed that the condensed phosphate ester has higher polarity than non-condensed phosphate ester, and therefore easily adsorbs to the surface of metal, thereby developing superior frictional resistance and superior wear resistance. Accordingly, it is presumed that the result similar to that described above is obtainable with a lubricating oil using the specific ester as the base oil and containing the condensed phosphate ester. Although the evaluation was made in the embodiment regarding the lubricating oils using dioctyl sebacate (DOS) as the base oil and resorcinol bis(diphenylphosphate) (RDP) as the condensed phosphate ester, the invention is not limited to this composition.

From the results of Test 3 for evaluating hydrolysis in lubricating oil and Frictional wear test, it was found out that the lubricating oil containing 0.1 wt % to 1 wt % of the condensed phosphate ester has superior frictional resistance and superior wear resistance, and that the hydrolysis of the above-described lubricating oil can be suppressed by using the lubricating oil in combination with the shaft or the bearing sleeve formed of the copper alloy containing 0.8 wt % to 5 wt % of lead. Further, in order to suppress the hydrolysis of the lubricating oil, the condensed phosphate ester is preferably contained in the lubricating oil in an amount of 0.1 wt % to 0.5 wt % since the mass reduction rate of the lubricating oil in FIG. 5 is considered satisfactory until about 10%. Moreover, in order to suppress the friction and wear (frictional wear) of the shaft and the bearing sleeve, the condensed phosphate ester is preferably contained in the lubricating oil in an amount of 0.25 wt % to 1.0 wt %. Accordingly, for suppressing both the hydrolysis of the lubricating oil and the friction and wear of the shaft and the bearing sleeve, the condensed phosphate ester is particularly preferably contained in the lubricating oil in an amount of 0.25 wt % to 0.5 wt %.

### (5) Test 4 for Evaluating Hydrolysis in Lubricating Oil

Lubricating oils containing the condensed phosphate ester and lubricating oils containing non-condensed phosphate ester were respectively prepared, and samples were prepared by immersing an alloy containing lead in each of the lubricating oils. The extent of the hydrolysis of lubricating oil was compared between these samples.

### [Preparation of Samples 37 to 44]

As the lubricating oils containing the condensed phosphate ester, the above-described lubricating oil “a1” containing 0.5 wt % of resorcinol bis(diphenylphosphate) (RDP), and a lubricating oil “d1” having a composition similar to that of the lubricating oil a1 except for containing 0.5 wt % of bisphenol-A bis(diphenylphosphate) (BDP) instead of the RDP, were prepared. Further, as the lubricating oils containing the non-condensed phosphate ester, the above-described lubricating oil “b1” containing 0.5 wt % of tricresyl phosphate (TCP) and the above-described lubricating oil “c1” containing 0.5 wt % of trixylenyl phosphate (TXP) were prepared.

As the alloy (lead-containing alloy), brass 1 (JIS C3604) containing 3.07 wt % of lead was prepared. The brass 1 was immersed in each of the four kinds of lubricating oils a1, d1, b1 and c1, and four kinds of Samples 37 to 40 were prepared. Further, as samples composed only of the lubricating oils without any alloy being immersed therein, Samples 41 to 44 composed only of the lubricating oils a1, d1, b1 and c1, respectively, were prepared. Note that the mass ratio of the lubricating oil in relation to the alloy was made to be 10:2 in each of Samples 37 to 40.

### [Method for Performing Test 4 for Evaluating Hydrolysis in Lubricating Oil]

HAST test was performed for Samples 37 to 44 in a similar manner as that in the above-described method for performing Test 1 for evaluating the hydrolysis in lubricating oil, except that the temperature and humidity in the environment in which Samples 37 to 44 were kept were changed to the following condition: a temperature of 120 degrees Celsius and a relative humidity of 90%. In this HAST test, the mass of each of Samples 37 to 44 was measured before the test (test time: 0 hour) and every 20 hours after starting the test; the mass reduction rate of the lubricating oil for each of Samples 37 to 44 was obtained based on the mass change of the lubricating oil. The result of the test is shown in Table 1 below.

TABLE 1

| | Lubricating Oil | | | | | | | | |
|---|---|---|---|---|---|---|---|---|---|
| | | Non- | | | | | | | |
| | Condensed | condensed | Lead- | Mass reduction rates of lubricating oil every 20 hours | | | | | |
| | phosphate | phosphate | containing | after starting the test (%) | | | | | |
| | ester | ester | alloy | 0 h | 20 h | 40 h | 60 h | 80 h | 100 h |
| Sample 37 | RDP¹⁾ | — | Yes | 0.0% | −0.5% | −1.2% | −3.2% | −5.8% | −10.0% |
| Sample 41 | | | No | 0.0% | −0.2% | −10.9% | −27.3% | −37.5% | −43.8% |
| Sample 38 | BDP²⁾ | — | Yes | 0.0% | −0.3% | −1.5% | −3.3% | −6.4% | −10.2% |
| Sample 42 | | | No | 0.0% | −0.2% | −1.4% | −15.0% | −31.8% | −41.5% |
| Sample 39 | — | TCP³⁾ | Yes | 0.0% | 0.0% | −2.3% | −4.5% | −8.3% | −13.0% |
| Sample 43 | | | No | 0.0% | −0.3% | −0.2% | −0.6% | −9.6% | −24.7% |
| Sample 40 | — | TXP⁴⁾ | Yes | 0.0% | −0.5% | −3.6% | −7.0% | −12.3% | −18.2% |
| Sample 44 | | | No | 0.0% | −0.1% | −0.8% | −6.0% | −20.0% | −32.2% |

¹⁾RDP: resorcinol bis(diphenylphosphate)
²⁾BDP: bisphenol-A bis(diphenylphosphate)
³⁾TCP: trieresyl phosphate
⁴⁾TXP: trixylenyl phosphate

The mass reduction rate of the lubricating oil after 100 hours from the start of Test 4 for evaluating the hydrolysis in lubricating oil was compared between Samples 37 and 38 and Samples 41 and 42. As shown in Table 1, Samples 37 and 38 where the alloy was immersed in the lubricating oil containing the condensed phosphate ester exhibited a low mass reduction rate of the lubricating oil corresponding to about 10% (10.0% and 10.2%, respectively). On the other hand, Samples 41 and 42 each composed only of the lubricating oil containing the condensed phosphate ester, and without any alloy immersed in the lubricating oil, exhibited a high mass reduction rate of the lubricating oil corresponding to more than 40% (43.8% and 41.5%, respectively). From these results, it was found out that when the lead-containing alloy is immersed in the lubricating oil containing the condensed phosphate ester, the mass reduction rate of the lubricating oil decreases to less than 25% of those of the lubricating oils where the lead-containing alloy is not immersed. This shows that, in the lubricating oil containing the condensed phosphate ester, the hydrolysis of the ester oil used as the base oil of the lubricating oil is efficiently suppressed by immersing the lead-containing alloy in the lubricating oil.

Next, the mass reduction rate of the lubricating oil after 100 hours from the start of Test 4 for evaluating the hydrolysis in lubricating oil was compared between Samples 37 and 38 and Samples 39 and 40. As shown in Table 1, Samples 39 and 40 where the alloy was immersed in the lubricating oil containing the non-condensed phosphate ester, instead of the condensed phosphate ester, exhibited the mass reduction rates of the lubricating oil of 13.0% and 18.2%, respectively, that were higher than the mass reduction rate of the lubricating oil of Samples 37 and 38 (about 10%) where the alloy was immersed in the lubricating oil containing the condensed phosphate ester. From these results, it was found out that the effect of suppressing the hydrolysis of the ester oil obtained by immersing the lead-containing alloy is higher in the lubricating oils containing the condensed phosphate ester (Samples 37 and 38) than in the lubricating oils containing the non-condensed phosphate ester (Samples 39 and 40).

Further, the mass reduction rate of the lubricating oil after 100 hours from the start of Test 4 for evaluating the hydrolysis in lubricating oil was compared between Samples 39 and 40 and Samples 43 and 44. As shown in Table 1, Samples 39 and 40 where the alloy was immersed in the lubricating oil containing the non-condensed phosphate ester exhibited the mass reduction rates of the lubricating oil (13.0% and 18.2%, respectively) that were lower than those in Samples 43 and 44 (24.7% and 32.2%, respectively) composed only of the lubricating oil containing the non-condensed phosphate ester and where the lead-containing alloy was not immersed. However, the decrease of the mass reduction rate of the lubricating oil obtained by immersing the lead-containing alloy in the lubricating oil containing the non-condensed phosphate ester was smaller than that in the lubricating oil containing the condensed phosphate ester (Samples 37 and 38). From these results also, it was found out that the effect of suppressing the hydrolysis of the ester oil obtained by immersing the lead-containing alloy is higher in the lubricating oils containing the condensed phosphate ester (Samples 37 and 38) than in the lubricating oils containing the non-condensed phosphate ester (Samples 39 and 40).

### Example 1

### Configuration of Fluid Dynamic Pressure Bearing Apparatus

A fluid dynamic pressure bearing apparatus 10 as shown in FIG. 1, was prepared. The fluid dynamic pressure bearing apparatus 10 includes a shaft 11 formed by stainless steel, a bearing sleeve 12 formed by free-cutting brass (JIS C3604, copper content rate: 3.07 wt %) and a lubricating oil 13 being the same as the above-described lubricating oil “a1”.

[Test with Actual Apparatus]

The fluid dynamic pressure bearing apparatus 10 according to the above-described configuration was assembled into the spindle motor 100 shown in FIG. 1. The spindle motor 100 was continuously driven at the rotational speed of 40000 min⁻¹in the following environment: a temperature of 60 degrees Celsius and a relative humidity of 90%. Then the value of motor driving electric current was measured at the start of driving (initial value) and after the elapse of 2000 hours. The value of motor driving electric current after the elapse of 2000 hours was within ±3% of the initial value, which was quite a small variation rate.

Next, the spindle motor 100 of Example 1 was disassembled after being driven continuously for 2000 hours and the lubricating oil was taken out of the spindle motor 100. The lubricating oil was visually observed; no change of the color (discoloration) and no wear debris (wear powder) and the like were observed. Further, the lubricating oil was analyzed by using a Fourier transform infrared spectrophotometer (FT-IR) and a gas chromatograph-mass spectrometry apparatus (GC/MS). The analysis resulted in no detection of degradation product (deterioration product) due to the hydrolysis of lubricating oil.

### Comparative Example 1

A fluid dynamic pressure bearing apparatus similar to the fluid dynamic pressure bearing apparatus of Example 1, except for using the lubricating oil “b1” containing the tricresyl phosphate (TCP) as the non-condensed phosphate ester instead of the lubricating oil “a1” containing the condensed phosphate ester, was prepared. The fluid dynamic pressure bearing apparatus of Comparative Example 1 was assembled into the spindle motor 100 shown in FIG. 1, and the test was performed with the similar condition of Example 1 described above. The value of motor driving electric current was measured at the start of driving (initial value) and after 2000 hours. The value of motor driving electric current after 2000 hours was twice the initial value, which was quite a large variation rate compared to Example 1.

Next, the spindle motor 100 of Comparative Example 1 was disassembled after being driven continuously for 2000 hours and the lubricating oil was taken out of the spindle motor 100. The lubricating oil was visually observed; the color of the lubricating oil was changed to greenish, and was turned to a gel state. Further, the lubricating oil was analyzed by using the FT-IR and the GC/MS. The analysis resulted in detecting a degradation product due to the hydrolysis of lubricating oil. In Comparative Example 1, it is presumed that the corrosive wear were generated inside the bearing apparatus 10 due to the use of the lubricating oil b1 not containing the condensed phosphate ester, and further the lubricating oil was hydrolyzed.

Although the fluid dynamic pressure bearing apparatus and the spindle motor of the present invention were specifically explained with the embodiments, the present invention is not limited to the embodiments.

The fluid dynamic pressure bearing apparatus of the present invention is capable of suppressing both of the hydrolysis of the lubricating oil and the wear of the shaft and/or the bearing sleeve. Accordingly, the fluid dynamic pressure bearing apparatus provides the durability and long service life even when used in a spindle motor with high rotational speed. The fluid dynamic pressure bearing apparatus of the present invention is particularly suitable for a polygon mirror scanner motor which rotates at a high speed exceeding 40,000 rpm.

What is claimed is:

1. A fluid dynamic pressure bearing apparatus comprising:
a shaft;
a bearing sleeve rotatably supporting the shaft; and
a lubricating oil filled between the shaft and the bearing sleeve;
wherein at least one of the shaft and the bearing sleeve is formed of a copper alloy containing 0.8 wt % to 5 wt % of lead; and
a base oil of the lubricating oil is a member selected from the group consisting of monoester, dibasic acid diester, diol ester and mixtures thereof, and the lubricating oil contains 0.1 wt % to 1 wt % of condensed phosphate ester.

2. The fluid dynamic pressure bearing apparatus according to claim 1, wherein a dynamic pressure generating groove is formed on at least one of an outer circumferential surface of the shaft and an inner circumferential surface of the bearing sleeve.

3. The fluid dynamic pressure bearing apparatus according to claim 1, wherein the monoester is a monoester obtained from esterification of straight-chain or branched-chain aliphatic monocarboxylic acid having 10 to 18 carbons, with saturated straight-chain aliphatic monohydric alcohol having 8 to 10 carbons or saturated branched-chain aliphatic monohydric alcohol having 8 to 16 carbons.

4. The fluid dynamic pressure bearing apparatus according to claim 1, wherein the diester is a diester obtained from esterification of aliphatic dibasic acid having 2 to 12 carbons with saturated straight-chain or branched-chain aliphatic alcohol having 3 to 22 carbons.

5. The fluid dynamic pressure bearing apparatus according to claim 1, wherein the diol ester is a diol ester obtained from esterification of saturated straight-chain or branched-chain aliphatic monocarboxylic acid having 4 to 18 carbons with saturated straight-chain aliphatic dihydric alcohol having 2 to 10 carbons or saturated branched-chain aliphatic dihydric alcohol having one branch or two or more branches and having 2 to 10 carbons.

6. The fluid dynamic pressure bearing apparatus according to claim 1, wherein the condensed phosphate ester is a member selected from the group consisting of resorcinol bis(diphenylphosphate), resorcinol bis(dixylenyl phosphate), bisphenol-A bis(diphenylphosphate) and mixtures thereof.

7. The fluid dynamic pressure bearing apparatus according to claim 1, wherein at least one of the shaft and the bearing sleeve is formed of a copper alloy containing 2 wt % to 5 wt % of lead.

8. The fluid dynamic pressure bearing apparatus according to claim 1, wherein the lubricating oil contains 0.1 wt % to 0.5 wt % of the condensed phosphate ester.

9. The fluid dynamic pressure bearing apparatus according to claim 1, wherein the lubricating oil contains 0.25 wt % to 1.0 wt % of the condensed phosphate ester.

10. The fluid dynamic pressure bearing apparatus according to claim 1, wherein the lubricating oil contains 0.25 wt % to 0.5 wt % of the condensed phosphate ester.

11. The fluid dynamic pressure bearing apparatus according to claim 1, wherein the base oil is dioctyl sebacate and the condensed phosphate ester is resorcinol bis(diphenylphosphate).

12. The fluid dynamic pressure bearing apparatus according to claim 1, wherein the copper alloy is brass containing copper and zinc.

13. A spindle motor comprising:
a fluid dynamic pressure bearing apparatus having a shaft, a bearing sleeve rotatably supporting the shaft, and a lubricating oil filled between the shaft and the bearing sleeve;
a rotor configured to rotate about the shaft; and
a stator configured to cooperate with the rotor to generate a rotation moment;
wherein at least one of the shaft and the bearing sleeve is formed of a copper alloy containing 0.8 wt % to 5 wt % of lead; and
a base oil of the lubricating oil is a member selected from the group consisting of monoester, dibasic acid diester, dial ester and mixtures thereof, and the lubricating oil contains 0.1 wt % to 1 wt % of condensed phosphate ester.

14. The spindle motor according to claim 13, wherein at least one of the shaft and the bearing sleeve is formed of a copper alloy containing 2 wt % to 5 wt % of lead.

15. The spindle motor according to claim 13, wherein the copper alloy is brass containing copper and zinc.

16. The spindle motor according to claim 13, wherein the shaft is formed of stainless steel; and the bearing sleeve is formed of the copper alloy containing 0.8 wt % to 5 wt % of lead.

17. The spindle motor according to claim 13, wherein a dynamic pressure generating groove is formed on at least one of an outer circumferential surface of the shaft and an inner circumferential surface of the bearing sleeve.

18. The spindle motor according to claim 13, wherein the condensed phosphate ester is a member selected from the group consisting of resorcinol bis(diphenylphosphate), resorcinol bis(dixylenyl phosphate), bisphenol-A bis(diphenylphosphate) and mixtures thereof.

19. The spindle motor according to claim 13, wherein the lubricating oil contains 0.1 wt % to 0.5 wt % of the condensed phosphate ester.

20. The spindle motor according to claim 13, wherein the base oil is dioctyl sebacate; and the condensed phosphate ester is resorcinol bis(diphenylphosphate).
